(19) United States
(12) Patent Application Publication
(10) Pub. No.: US 2009/0222485 A1
(43) Pub. Date: Sep. 3, 2009

(54) Product information system for aggregating and classifying information from multiple sources with update ability

(75) Inventors: David A. Wassmann, Bloomfield Hills, MI (US); William D. Musick, White Lake, MI (US); Daniel J. Terry, Ann Arbor, MI (US); Todd A. Ridley, Detroit, MI (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: NeoSynergy, Inc., Bloomfield Hills, MI (US)

(21) Appl. No.: 12/074,426

(22) Filed: Mar. 4, 2008

(30) Foreign Application Priority Data
Mar. 3, 2008 (CA) CA 2623796

(51) Int. Cl. G06F 17/30

(52) U.S. Cl. 707/104.1; 707/E17.044

(57) ABSTRACT

A framework and method for aggregating a plurality of product information accessed from a plurality of information sources. The framework comprises an aggregation module for receiving the product information such as vehicle details and for assigning a unique identifier to each product definition such as a vehicle advertisement associated with the product information. the framework includes a classification module for determining at least one classification for each of the product definitions according to a set of predefined classifications, such as vehicle make/model and dealership. The framework also has a storage for storing each of the product definitions according to the respective at least one classification and the respective unique identifier, such that the product definitions are retrievable from the storage in view of search parameters received from a potential consumer for the product defined in the product definition. The framework also has an update module for receiving update information associated with a specified unique identifier and for amending with the update information the product definition in the storage matching the specified unique identifier.

### FIELD OF THE INVENTION

This invention relates to aggregation of updatable product definitions received from various information sources.

### BACKGROUND OF THE INVENTION

Use of the Internet for purchase of consumer products is growing in popularity due to the ever-expanding placement of information that is accessible on-line through various search tools, such as search engines and specialized consumer product portals. Placement of advertising content on-line has grown in popularity due to advantages in reaching a wider target audience. Further, the Internet is fast becoming the primary information search tool for obtaining information about products, places, people, etc. Unfortunately, the Internet is also quickly becoming a casualty of it's own success due to large amounts of available data and the inability of users to find consumer products that are relevant to the users, such as near the users' location, in the appropriate price range. In general, it is common practice to post copies of newsprint ads/circulars on company websites, however the ability to search the information contents of the posted copies is limited. Further, it is difficult for retailers to manage their product inventories to match published details of their products in the form of advertisements in a product information aggregated environment.: Further, currently it is difficult for retailers to coordinate generation of advertisements and other product descriptions for publication electronically, based on the contents of their product information databases.

### SUMMARY OF THE INVENTION

It is an object of the present invention to provide an entity navigation environment to obviate or mitigate at least some of the above-presented disadvantages.

The Internet is becoming a casualty of it's own success due to large amounts of available data and the inability of users to find consumer products that are relevant to the users, such as near the users' location, in the appropriate price range. In general, it is common practice to post copies of newsprint ads/circulars on company websites, however the ability to search the information contents of the posted copies is limited. Further, it is difficult for retailers to manage their product inventories to match published details of their products in the form of advertisements in a product information aggregated environment. Further, currently it is difficult for retailers to coordinate generation of advertisements and other product descriptions for publication electronically, based on the contents of their product information databases. Contrary to current methods and systems there is provided a framework and method for aggregating a plurality of product information accessed from a plurality of information sources. The framework comprises an aggregation module for receiving the product information such as vehicle details and for assigning a unique identifier to each product definition such as a vehicle advertisement associated with the product information. the framework includes a classification module for determining at least one classification for each of the product definitions according to a set of predefined classifications, such as vehicle make/model and dealership.

The framework also has a storage for storing each of the product definitions according to the respective at least one classification and the respective unique identifier, such that the product definitions are retrievable from the storage in view of search parameters received from a potential consumer for the product defined in the product definition. The framework also has an update module for receiving update information associated with a specified unique identifier and for amending with the update information the product definition in the storage matching the specified unique identifier.

According to one aspect of the invention there is provided a framework for aggregating a plurality of product information accessed from a plurality of information sources, the framework comprising: an aggregation module for receiving the product information and for assigning a unique identifier to each product definition associated with the product information; a classification module for determining at least one classification for each of the product definitions according to a set of predefined classifications; a storage for storing each of the product definitions according to the respective at least one classification and the respective unique identifier, such that the product definitions are retrievable from the storage in view of search parameters received from a potential consumer for the product defined in the product definition; and an update module for receiving update information associated with a specified unique identifier and for amending with the update information the product definition in the storage matching the specified unique identifier.

The framework can also have the predefined classifications as selected from the group comprising: product type; product pricing; product availability; product location; retailer location; and retailer identification information. The framework can also have the update information selected from the group comprising: product unavailability and product pricing change. The update information can contain information intended to update data in the storage selected from the group comprising: the type of the classifications of the product definition, the content of the classifications of the product definition; and product details of the product definition.

A further aspect of the present invention is a method for aggregating a plurality of product information accessed from a plurality of information sources, the method comprising the acts of: receiving the product information and assigning a unique identifier to each product definition associated with the product information; determining at least one classification for each of the product definitions according to a set of predefined classifications; storing each of the product definitions according to the respective at least one classification and the respective unique identifier, such that the product definitions are retrievable from the storage in view of search parameters received from a potential consumer for the product defined in the product definition; receiving update information associated with a specified unique identifier; and amending with the update information the product definition in the storage matching the specified unique identifier.

### BRIEF DESCRIPTION OF THE DRAWINGS

Exemplary embodiments of the invention will now be described in conjunction with the following drawings, by way of example only, in which:

FIG. 1 is a block diagram of components of a consumer product information system;

FIGS. 2 shows an example framework of the system of FIG. 1;

FIG. 3 is a block diagram of an example computing device for implementing the components of the framework of FIG. 1;

FIG. 4 shows a further example consumer interface generated by the framework of FIG. 2; and

FIG. 5 is a flowchart of operation of the framework of FIG. 1.

### DETAILED DESCRIPTION OF THE PREFERRED EMBODIMENT(S)

### Consumer Product Information System 10

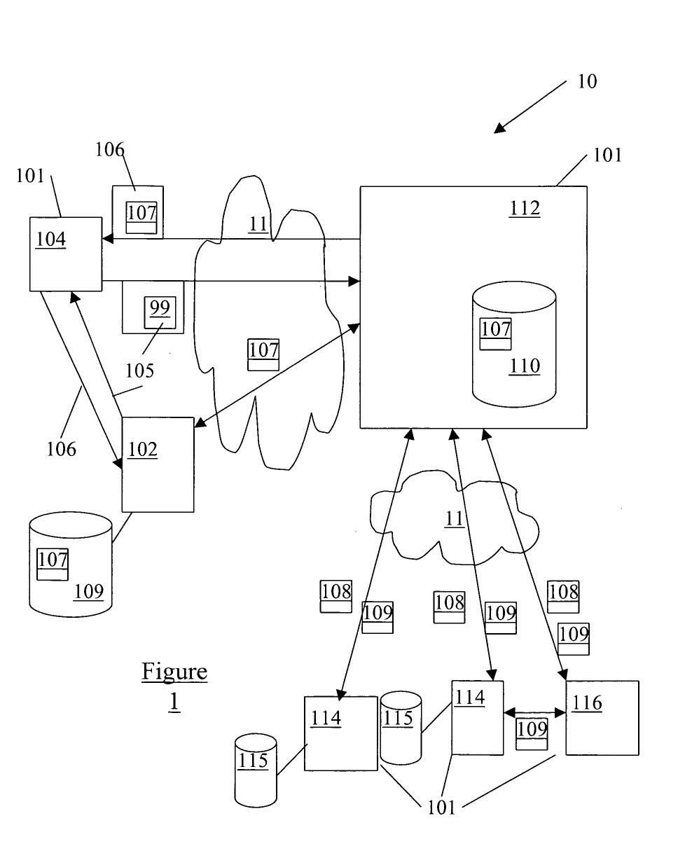

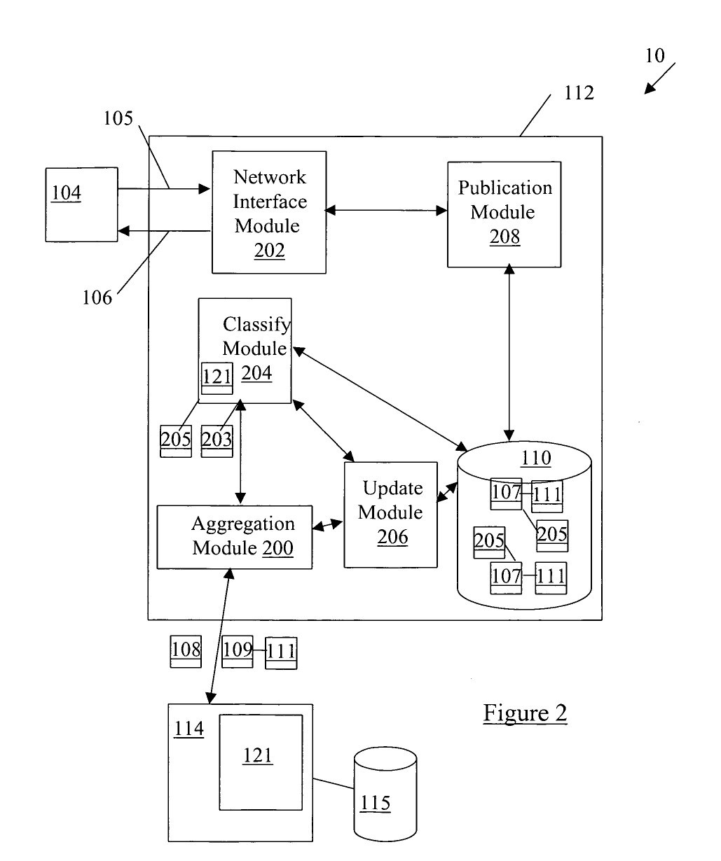

Referring to FIGS. 1 and 2, shown is a consumer product information system 10 for providing published consumer product definitions 107 to a plurality of potential consumers 104, via search results 106, based on one or more search requests 105. One example of the published consumer product definitions 107 is a product advertisement 107 that provides product details such as price, location, and/or product description, as further described below. The search request 105 of the consumer 104 includes search parameters 99 (e.g. keyword terms, phrases, etc.) for use in helping to identify the search results 106 from an electronic storage 110 (e.g. database) that are relevant to the potential consumer 104 of the product defined in the product definition 107. For example, the consumers 104 could search vehicle “for sale” information in the database 110 of the system 10 to find the sorted (e.g. lowest) advertised new vehicle prices (associated with the corresponding vehicle advertisement 107) in various/selected market(s) across the country. Accordingly, the search parameters 99 could include parameters such as but not limited to: product type (e.g. vehicle make, manufacturer); product retailer (e.g. specific dealerships having the desired vehicle); and/or product location (e.g. physical location of the vehicle dealership). Matches to at least some of these search parameters 99 would be included in the contents of the various product definitions 107 stored in the database 110.

The database 110 is hosted by or otherwise accessed through an information aggregation framework 112, which aggregates consumer product information 108 from various information sources 114 (e.g. product manufacturers, product retailers such as vehicle dealerships) and/or third party information sources 116 (such as published advertisements in flyers, magazines, newsprint, etc.). This aggregated product information 108 is then made available as the product definitions 107 to the consumers 104 via the database 110. The aggregation of the product information 108 in the electronic database 110 can be applied to any product retailer (e.g. Canadian Tire, Home Depot, Zellers, Loblaws, vehicle dealerships or other vehicle retailers) in a competitive marketplace for similar products through digital aggregation of product information (e.g. from physical and/or virtual advertisements), as further described below. It is recognised that the product information 108, when received by the framework 112, may already contain a formatted product definition 107 (e.g. product advertisement) as part of the product information 108. Further, the framework 112 may make available the formatted product definition 107 to the consumer 104, as received, or may modify the received formatted product definition 107 before making it available to the consumer 104. It is also recognised that the framework 112 can supply the product definition 107 to a third party network interface 102 (e.g. independent web portal) for storage in a storage 109, who then makes the product definitions 107 available to the consumers 104 from the storage 109 via corresponding ones of the search requests 105 and results 106. In any event, it is recognised that update information 109 can be supplied to the third party network interface 102, as desired.

As further described below, periodic update information 109 (received/obtained from the information sources 114,116) is associated with corresponding product definitions 107, in order to have the product definitions properly reflect the status (e.g. revised product availability, revised product price, revised product financing, etc.) of the products of the information sources 114. Each of the product definitions 107 is assigned a unique identifier 111 by the framework 112 when they structured and classified for storage in the database 110, whereby this unique identifier 111 is communicated to the information sources 114,116 for each of the product definitions 107 received in the product information 108. Accordingly, subsequent update information 109 sent by the information sources 114,116 contains the appropriate unique identifier 111, such that the framework 112 can match the update information 109 to the appropriate product definition 107. The unique identifier 111 can contain identifier information (e.g. alpha-numeric) assigned by the framework 112, which can include information about the specific information source and/or retailer associated with the product of the product definition 107.

Communications between the consumers 104, the information aggregation framework 112, and the information sources 114 are facilitated via one or more communication networks 11 (such as intranets and/or extranets—e.g. the Internet). The product information system 10 can include multiple consumer 104, one or more information aggregation frameworks 112 (e.g. each framework directed to a specified product type—such as a vehicle framework, an electronics product framework, etc.), multiple information sources 114, 116, respective multiple hosting devices 101, and one or more coupled communication networks 11, as desired. Examples of the devices 101 are provided below.

### Search Request 105

The consumers 104 can be potential product purchasers (e.g. people, named organizations, etc.) that desire to purchase the product based on product details contained in the product definitions 107 that are available from the framework 112. The product definitions 107 could contain product data such as but not limited to: image data; video data; audio data; and/or text/literary data, such that the product data provides information for use by the consumer 104 in making a decision whether to or not to purchase the product. The user 104 submits the search request 105 to the framework 112 over the network 11 in order to find out about the product details and associated price, delivery, and/or location information of the product, through matching of at least some of the search parameters 99 in the request 105 with contents of the product definition 107. For example, the consumer 104 wants to locate all vehicles of a certain make and model and year in the state of New York. These parameters would be part of the search request 105, which is then sent to the framework 112 for matching against the contents of the product definitions 107 stored in the database 110.

Further, it is recognised that the aggregation of the product information 108 in the database 110 (as sourced from various independent physical/virtual product definitions, such as product advertisements, from the information sources 114,116) can facilitate higher efficiency and data integrity through vertical specialization, such that the product definitions can be organized as product and/or vendor centric (e.g. vehicle and dealership centric input). Therefore, instead of the consumer 104 typing a product of vendor name for insertion into the search request 105 (e.g. a vehicle or dealership name), the consumer can chose the name from a list that is updated regularly. This list of available products, vendors/retailers, and/or location of the vendors/retailers could be provided online by a network interface module 202 (see FIG. 2) of the framework 112, further described below.

### Third Party Information Sources 116

The third party information sources 116 can be used to obtain product definitions 107 from traditional advertising media, such as published advertisements in flyers, magazines, newsprint, etc.

For example, the information sources 116 can have a product definition generation system 120 for producing the product definitions 107 in electronic form, as converted from the traditional advertising media. For example, the pictures or images of the product information 108 (e.g. a newspaper/magazine/flyer advertisement) can be scanned and then transmitted as an electronic image as part of the product information 108. Further, textual information in the pictures/images of the product advertisements are converted to text with a suitable OCR (Optical Character Recognition) process as part of the system 120. Once the textual (e.g. alpha-numeric) data of the advertisements has been obtained, this extracted data is provided for use as part of the product definition 107.

It is recognised that the product information 108 could already be in electronic form that is in image/picture format containing both visual details of the product as well as embedded alpha-numeric product information, such that in the image/picture format the alpha-numeric product information is not searchable by standard text/numeric search strings. As described above for the traditional advertising media, these electronic pictures/images could subjected to recognition processes for the embedded alpha-numeric product information. Once the textual (e.g. alpha-numeric) data of the advertisements has been obtained, this extracted data is provided for use as part of the product definition 107.

An example process of the system 120 for converting the physical ad information as electronic product information 108 suitable for storing in the electronic database 110 is as follows:

1. A newsprint/magazine/circular/flyer distributor couriers periodically published issues, covering a plurality of markets (e.g. by a set time) to the third party information source 116;

2. The system 120 scans all the product ad pages (for a selected product—e.g. vehicles) into electronic picture files (e.g. PDF files); and

3. A group of data entry people and/or OCR systems access the picture files and facilitate the entry (via a process of manual and/or automatic information recognition) of the product data contained in the picture files as the electronic product information 108 that is then sent to the framework 112 for storage in the electronic database 110, so that the product data (e.g. as product definitions 107—one example being product advertisements) is then searchable by the consumers 104 via a network interface module 202.

It is recognised that periodically, the electronic product information 1098 is uploaded from the information sources 116 to the framework 112, aggregated according to product and/or vendor classifications, and thereby made available as new product definitions 107 obtainable by the consumers 104.

### Information Aggregation Framework 112

Referring to FIG. 2, shown is an example of the framework 112 for aggregating, by an aggregation module 200, the plurality of product information 108 obtained/received from the plurality of the information sources 114,116 for storage in the database 110. It is recognised that the product information 108 can come from the vendor databases 115, synchronously and/or asynchronously with respect to communications between the framework 112 and the information sources 114. Once stored, the aggregated (from a plurality of the information sources 114,116) product information 108 (including the product definitions 107) is accessed, via the network interface module 202, by the plurality of consumers 104. A publication module 208 is provided the parameters 99 of the received search request 105 from the interface module 202 and then searches the database 110 for suitable matching product definitions 107. The matched product definitions 107 are returned to the interface module 202 as the search results 106, which are then communicated back to the consumer 104, over the network 11, in response to the received search request 105.

Further, the framework 112 can have a classification module 204 for sorting the aggregated product information 108 according to predefined categories 205 (e.g. product type/make/model, product retailer/dealer, product price category, and/or product/retailer location) before the product information 108 is stored in the database 110. Further, the framework 112 has an update module 206 for updating the product information 108 in the database 110, based on the periodic updates 109 received from the information sources 114, 116. Each of the product definitions 107 is assigned the unique definition identifier 111 by the framework 112 (for example by the classification module 204 and/or the aggregation module 200), such that the stored product definition 107 can be later accessed in the database 110, by the same identifier 111, for facilitating application of update information 109, as further described below.

### Aggregation Module 200

The aggregation module 200 is responsible for communicating with the information sources 114,116 over the network 11, in order to receive various product information 108. The product information 108 can be defined using a structured definition language such as but not limited to the Standard Generalized Markup Language (SGML), which defines rules for how a document can be described in terms of its logical structure (headings, paragraphs or idea units, and so forth). SGML is often referred to as a meta-language because SGML provides a “language for how to describe a language.” A specific use of SGML is called a document type definition (DTD), which defines exactly what the allowable language is. For example, Hypertext Markup Language (HTML) is an example of a structured definition language for defining the product information 108 . A further example of the structured definition language is Extensible Markup Language (XML), which defines how to describe a collection of data.

The module 200 recognises the product definitions 107 contained in the product information 108 (e.g. a named vehicle, offered for a certain price, by a named dealership, in a certain geographical location, and/or for a specified time) and notifies the information source 114,116 of the assigned unique identifier 111. The module 200 then informs the classification module 204 of the received product definitions 107 for classification. It is recognised that the module 220 can be configured to expect receipt of the product information 108 and/or update information 109 by a set date and time, for example that information 108,109 obtained from the third party sources 116 via regularly published media (e.g. newspapers, flyers, circulars, magazines). Further, it is recognised that the module could be configured as a Web portal for interaction with the information sources 114,116 over the network 11. It is also recognised that the module 200 could be part of the network interface module 202, as desired.

The module 200 can also facilitate registration of the information sources 114 (e.g. dealerships) with the framework 112. The source 114 would provide their registration information, such as retailer/dealer name, location, and contact details. The communication of this registration information can include communication modes such as but not limited to: voice communication via phone; written communication via network messaging (e.g. email, facsimile); and/or others as desired.

It is recognised that the sources 114 registered with the framework 112 could be issued framework ID and password (optional), which uniquely identifies the particular source 114. The framework ID could be associated with the product information 108, thus facilitating the receipt of subsequent product information 108 and processing by the framework 112 for storage in the database 110.

Further, it is recognised that the aggregation module 200 can include a coordinated set of programs that can represent a spider that goes to every page or representative pages on every specified retailer Web site of the network 11 that wants to be searchable and reads it, using hypertext links on each page to discover and read a site's other pages. The spider can be configured to automatically recognise product information 108 that would be suitable for storing in the database 110 as the product definitions 107.

### Classification Module 204

The classification module 204 is configured for sorting the aggregated product information 108 according to predefined categories 205 (e.g. product type/make/model, product retailer/dealer, product price category, and/or product/retailer location) before the product information 108 is stored in the database 110 as the product definitions 107 (e.g. product advertisements). For example, structured records are extracted out of the received product information 108 and assembled as the product definitions 107 (e.g. advertisements) and then stored in the database 110. The classified product definitions 107 can comprise advertisement orders received from the plurality of information sources 114 or already published advertisements (e.g. from the information sources 114,116). In the case of an advertisement order, details of the product are contained in the product information 108 and the module 204 from this information 108, according to a predefined product definition template 203, generates the corresponding product definition 107.

For example, the product definition template 203 could include the components of a product picture/image (e.g. vehicle picture), product name (e.g. vehicle make and model and year), product pricing (e.g. vehicle purchase and/or leasing information), product/retailer location (e.g. dealership address), retailer contact details (e.g. dealership telephone number or email), and/or product descriptive details (e.g. vehicle sticker information such as mileage, options, etc.). It is recognised that one or more of the components could be considered as classifications 205 by the framework 112. The database 110 then comprises a structured record (e.g. containing one or more of the above listed components) for each product definition 107 that has been captured and classified by the framework 112. Each record comprises a plurality of fields for storing and structuring the various data components extracted/identified from each product information 108 set processed by the framework 112. It is recognised that the product information 108 may already contain suitable product definitions 107 and therefore the module 204 would then classify the received product definitions 107 for subsequent retrieval from the database 110 according to their classification of the product details (e.g. vehicle make/model/year and/or dealership).

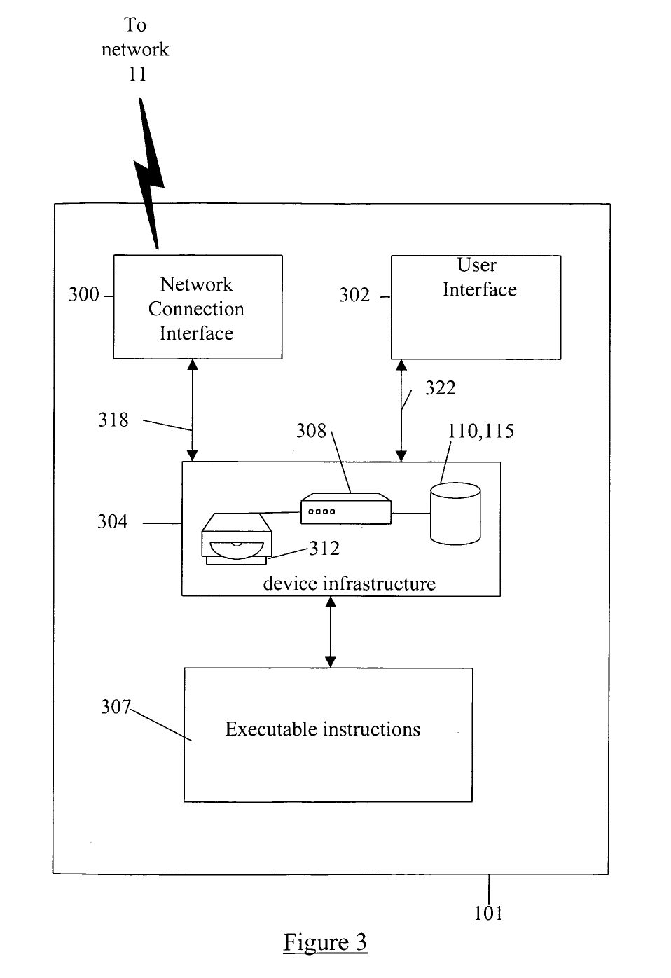

In view of the above, the module 204 captures and/or formats the content of the product information for identifying/defining and categorizing appropriate product definitions 107 (e.g. product advertisements) for storage in the database 110. For example, each advertisement is classified based on predefined classification categories 205 that match extracted data units from the content of the product information 108. Each of the data units (and corresponding classification 205) is stored a corresponding field of a record in the electronic database 110 that pertains to the product definition 107, which is labelled by the unique identifier 111. Further, the textual content and the layout and/or the position of the data in the product definition 107 (for display in the user interface 302 of the consumer's device—see FIG. 3) can be included in the database 110.

The classification module 204 can also contain a product definition 107 generation engine 121 that parses product information 108 obtained directly from a vendor database 115 (e.g. a Dealer Management System containing vehicle descriptions and vehicle availability/inventory) and then using the predefined template 203 to extract the desired advertisement details from the vendor database 115 and then send the extracted product details to the Web portal (i.e. the aggregation module 200) for assignment of the unique identifier 111. This engine 121 provides for the vendor to tie into product inventory levels and to have product definitions 107 built directly for online display to the consumer 104 via the network interface module 202. The vendor database 115 could have indicators coupled to selected products, and/or product data subsets, which would direct the engine 121 on which products/data to use for creation of the product definitions 107. Use of the engine 121 could bypass the need for scanning and recognition of product data from the picture/image files obtained and processed by the third party information sources 116. It is also recognised that the generation engine 121 could be hosted by the various information sources 114, independently or in cooperation with product definition generation capabilities of the classification module 204. In any event, it is recognised that the generation engine 121 has access to selected contents of the vendor/retailer database 115.

### Update Module 206

The update module 206 accesses or is otherwise provided with the product definition identification 111 that is associated with the update information 109 received by the aggregation module 200. This update information can be obtained from or otherwise accessed with respect to the vendor databases 115, in order to reflect updates to the product information 108 contained therein. The aggregator module 200 can assign or otherwise recognise the identification 111 to/of the update information 109. The update module 206 can then access or otherwise be provided the update information 109 and the associated identification 111 (via the aggregation module 200) and then access the corresponding product definition 107 in the database 110 (via the assigned identification 111). The update module 206 uses the update information 109 to add new data, remove existing data, and/or amend existing data from the corresponding product definition 107 associated with the assigned identification 111. In this manner, the product definitions 107 in the database 110 can be dynamically maintained to correspond with the product information 108 in the product inventory database 115 of the respective information source 114. It is recognised that the update information 109 can also be supplied to the third party information sources 116 by the information sources 114. The update information 109 can be sent to the framework 112 by the information source 114 on a periodic basis (for example as periodically scheduled on a predefined schedule or more dynamically whenever there is an update to the product information 108 in the database 115), or otherwise requested by the framework 112 from the information source 114, for example.

An example of these updates 109 is to account for vehicle dealer inventory details (e.g. vehicle is sold and no longer available, vehicle price change, vehicle leasing information change, etc.). In the case of product unavailability, such an update 109 could result in removal of the corresponding product definition 107 from the database 110, such that the consumer 104 would no longer be able to access this product definition 107 (e.g. vehicle advertisement). Otherwise in the case of product unavailability, such an update 109 could result in modification of the product definition 107 to indicate that the product (e.g. vehicle) was sold, whereby the updated product definition 107 would remain accessible by the consumer for a specified or otherwise predefined period of time and then deleted from the database 110 (or otherwise become inaccessible by the consumer 104 via the network interface 202). Outdated/expired product definitions 107 can be removed from the electronic database 110, either in relation to received update information 109 and/or in response to a predefined time/expiry period (e.g. product definitions are automatically deleted from the database 110 after a set time period. It is also recognised that the update information 109 can contain information intended to amend or otherwise update the type and/or content of the classifications 205 of the product definition 107, rather that the product details (e.g. vehicle colour, options, picture, etc.) of the product definition 107 itself.

### Network Interface Module 202

The module 202 can be part of the network connection interface 300 (see FIG. 3) of the device 101 operating the framework 112. The module 202 can communicate synchronously or asynchronously with the device 101 of the consumer 104 over the network 11 to receive or otherwise structure the search requests 105. For example, the module 202 could be a Web service as a software system designed to support interoperable machine-to-machine interaction over the network 11, between the framework 112 and the consumers 104. The Web service of the framework 112, as facilitated by the module 202 can be configured as a series of Web APIs that can be accessed over the network 11 by the consumer 104 and then executed on the framework 112 hosting the requested services.

The Web service definition can encompass many different systems, such as clients and servers that communicate using XML messages that follow the SOAP standard. Also, the module 202 could provide a machine-readable description of the operations supported by the framework 112 written in the Web Services Description Language (WSDL).

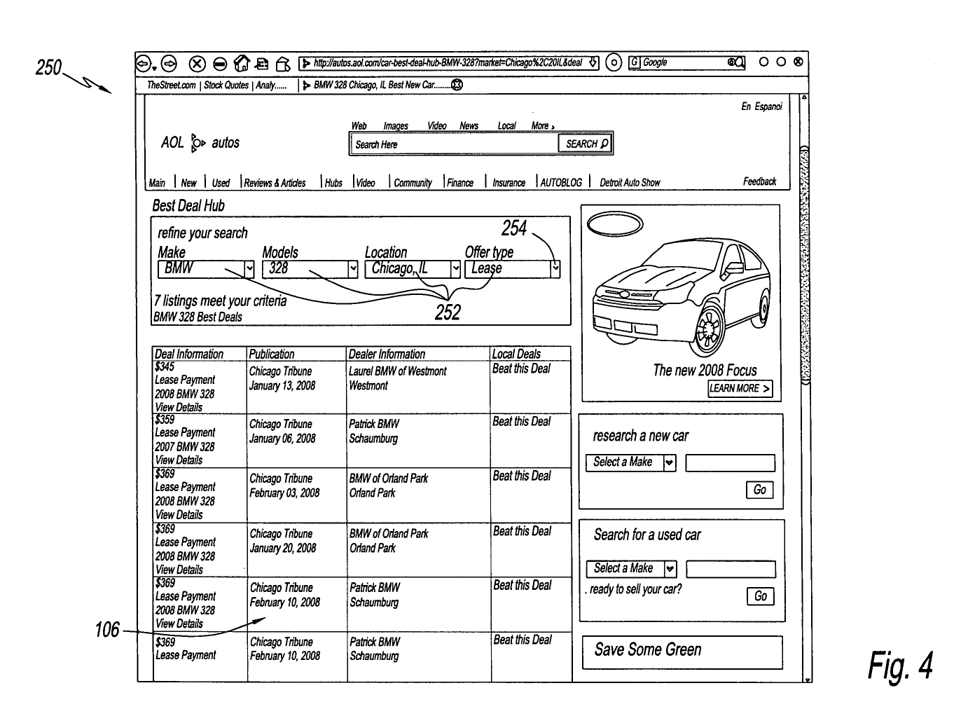

For example, the module 202 provides to the consumer 104 an electronic interface 250 (see FIG. 4) for access to the product definitions 107, as searched in the database 110 through any subset of the product details via the search parameters 99. For example, the electronic interface can be a Web portal offering a structured product search engine, i.e. the consumers 104 via their browser access the contents of the electronic database 110 over the network 11 via the framework 112 that hosts the product search engine. For example, the consumers 104 could search vehicle “for sale” information in the database 110 to find the lowest advertised new vehicle prices in various markets across the country. The electronic interface 250 can present predefined search parameter 99 selections 252 (e.g. product classifications as selections via suitable user interface control elements 254) as product and/or vendor centric (e.g. vehicle and dealership centric input). Therefore, instead of the consumer 104 typing a product of vendor name in the search engine search string (e.g. a vehicle or dealership name), the consumer 104 can chose a name 252 from a list element 254 that is updated regularly. It is recognised that the selections 252 can pertain to the classifications that were assigned to the product definitions 107 via the classification module 204.

Examples of user interface control elements 254 of the interface 250 can include such as but not limited to a dropdown list that is similar to a list box, which allows the consumer 104 to choose one or more values from the list. When the dropdown list is inactive it displays a single value. When activated, the dropdown list displays (drops down) a list of values (e.g. classifications), from which the consumer 104 may select. When the consumer 104 selects a new value the control element reverts to its inactive state, displaying the selected value. The control elements 254 can include, for example, a combo box having an editable entry portion of the list. The navigation field of a web browser is an example of a combo box. A further example of the control elements 254 is a list box or tabs that provide for the selection of one or more classifications at a time by the consumer 104. A further type of example control element 254 is a Pop-up/down menu, whereby pop-ups are used to select a single classification from a list while pop-downs are used to issue commands (e.g. customized search terms) or in cases where multiple classifications can be selected. In any event, it is recognised that the control elements 254 can be used by the consumer 104 to formulate at least some of the search parameters 99 of the search request 105, for example.

The module 202 can include receipt and transmit sub-modules can be part of the network connection interface module 202, in accordance with the parameters 99 of the search request 105 as well as the generated search results 106, as desired.

### Publication Module 208

A publication module 208 of the framework 112 is provided the parameters 99 of the received search request 105 (e.g. selected classifications 205 by the consumer 104) from the interface module 202, and then searches the database 110 for suitable matching product definitions 107. The matched product definitions 107 are returned to the interface module 202 as the search results 106, which are then communicated back to the consumer 104, over the network 11, in response to the received search request 105.

For example, the module 208 accesses the assigned classifications 205 of the product definitions 107 in the database 110, in order to link/match those product definitions 107 that are assigned the classifications 205 matching the parameters 99 of the search request 105. It is noted that the classifications 205 used in matching product definitions 107 to the search request 105 can be used in addition to other search parameters 99 directed to the contents of the product definitions 107.

It is recognised that metadata can be used to define a set/list of descriptors (words, phrases, etc.) for indexing (e.g. classifying) the assigned classifications 205 and/or the contents of the product definitions 107.

Accordingly, the module 208 can provide a search engines using categories 205 (for example) to access the product definitions 107 in the database 110, based on the provided parameters 99 of the search request 105. The engine can process text query to provide search hit files that will display on the consumer's device 101 product definitions 107 (e.g. product advertisements) that are associated with the entered text query. Product information 108 associated with product definitions 107 may consist of information such as but not limited to, product description/details, pricing, retailer locations and availability, online purchase capabilities, purchase statistics, information about similar products, retailer contact information, and the like. Additionally, the product definitions 107 may contain network links to the product manufacturer and/or the retailer's Web site/online store, as desired. The module 208 can include a generator module for generating the matched product definitions 107 as a rendered display or as display data that can be used to subsequently render the display 302 of the matched product definitions on the display of the consumer device 101 (see FIG. 3).

Further, it is recognised that the modules 200,202,204,206,208 can be configured to operate interactively as shown, the operations/functionality of the selected modules 200,202,204,206,208 can be combined or the operations/functionality of the selected modules 200,202,204,206,208 can be further subdivided, as desired. Further, it is recognised that the modules 200,202,204,206,208 can communicate or otherwise obtain their calculated results from one another or can store their respective calculated results in the storage 110 for subsequent retrieval by another module 200,202,204,206,208 there-from.

### Computing Devices 101

Referring to FIGS. 1 and 3, each of the above-described components of the system 10, i.e. the consumer 104, the framework 112, the information sources 114,116 can be implemented on one or more respective computing device(s) 101. The devices 101 in general can include a network connection interface 300, such as a network interface card or a modem, coupled via connection 318 to a device infrastructure 304. The connection interface 300 is connectable during operation of the devices 101 to the network 11 (e.g. an intranet and/or an extranet such as the Internet), which enables the devices 101 to communicate with each other as appropriate. The network 11 can support the communication of the search request 105 and the corresponding search results 106 between the components of the system 10.

Referring again to FIG. 3, the devices 101 can also have a user interface 302, coupled to the device infrastructure 304 by connection 322, to interact with a user (e.g. information source 114,116, consumer 104, framework 112 administrator, etc.). For example, the consumer 104 to view and interact with the electronic interface supplied by the interface module 202 uses the user interface 302 of the device 101. The user interface 302 can include one or more user input devices such as but not limited to a QWERTY keyboard, a keypad, a trackwheel, a stylus, a mouse, a microphone and the user output device such as an LCD screen display and/or a speaker. If the screen is touch sensitive, then the display can also be used as the user input device as controlled by the device infrastructure 304. For example, the user interface 302 for the devices 101 used by the consumers 104 can be configured to interact with a web browser (e.g. applications 307) to formulate the search requests 105 as well as process the received search results 106 (e.g. review the various details of the products offered for sale). For the devices 101 used by the framework 112, the user interfaces 302 can be used by a framework 112 administrator to monitor (e.g. manually or automated through software—e.g. applications 307) the classification of the product definitions 107 and associated update information 109.

Referring again to FIG. 3, operation of the devices 101 is facilitated by the device infrastructure 304. The device infrastructure 304 includes one or more computer processors 308 and can include an associated memory 110,115 (e.g. a random access memory). The computer processor 308 facilitates performance of the device 101 configured for the intended task through operation of the network interface 300, the user interface 302 and other application programs/hardware 307 of the device 101 by executing task related instructions. These task related instructions can be provided by an operating system, and/or software applications 307 located in the memory 110,115, and/or by operability that is configured into the electronic/digital circuitry of the processor(s) 308 designed to perform the specific task(s). Further, it is recognized that the device infrastructure 304 can include a computer readable storage medium 312 coupled to the processor 308 for providing instructions to the processor 308 and/or to load/update client applications 307. The computer readable medium 312 can include hardware and/or software such as, by way of example only, magnetic disks, magnetic tape, optically readable medium such as CD/DVD ROMS, and memory cards. In each case, the computer readable medium 212 may take the form of a small disk, floppy diskette, cassette, hard disk drive, solid-state memory card, or RAM provided in the memory module 110,115. It should be noted that the above listed example computer readable mediums 312 can be used either alone or in combination. The device memory 110,115 and/or computer readable medium 312 can be used to store the registration information of the information sources 114,116, such that registration information is used in processing of the product information 108 submitted from the information sources 114,116 to the framework 112. Further, the device memory 110,115 can also be used by the framework 112 as a means to store and access profile descriptions 107 that match the search parameters 99 (e.g. classifications 205) included in the search request 105.

Further, it is recognized that the computing devices 101 can include the executable applications 307 comprising code or machine readable instructions for implementing predetermined functions/operations including those of an operating system, a web browser, the framework 112 for example. The processor 308 as used herein is a configured device and/or set of machine-readable instructions for performing operations as described by example above. As used herein, the processor 308 may comprise any one or combination of, hardware, firmware, and/or software. The processor 308 acts upon information by manipulating, analyzing, modifying, converting or transmitting information for use by an executable procedure or an information device, and/or by routing the information with respect to an output device. The processor 308 may use or comprise the capabilities of a controller or microprocessor, for example. Accordingly, any of the functionality of the framework 112 (e.g. modules 200, 202, 204, 206, 208, and subset thereof) may be implemented in hardware, software or a combination of both. Accordingly, the use of a processor 308 as a device and/or as a set of machine-readable instructions is hereafter referred to generically as a processor/module for sake of simplicity. Further, it is recognised that the framework 112 can include one or more of the computing devices 101 (comprising hardware and/or software) for implementing the modules 200, 202, 204, 206, 208, or functionality subset thereof, as desired.

It will be understood that the computing devices 101 of the consumers 104 may be, for example, personal computers, personal digital assistants, mobile phones, and content players. Server computing devices 101 can be configured for the framework 112 and the information sources 114,116 as desired. Further, it is recognised that each server computing device 101, although depicted as a single computer system, may be implemented as a network of computer processors, as desired.

### Operation 500 of the Framework 112

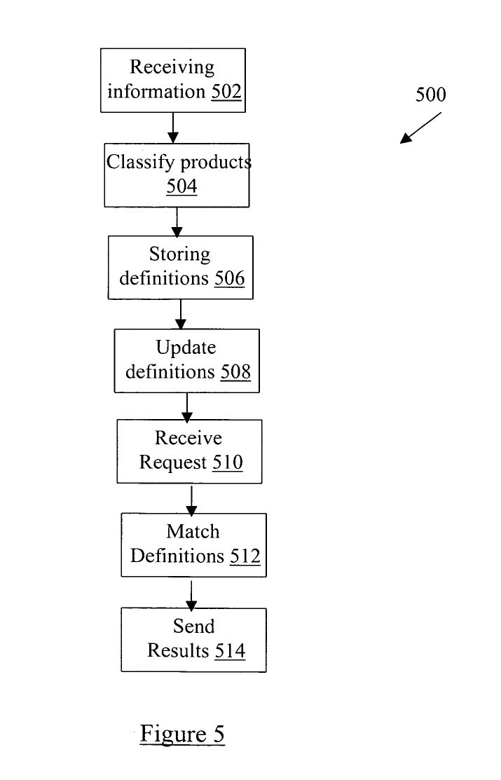

Referring to FIG. 5, shown is an example operation of the framework 112 for aggregating a plurality of product information accessed from a plurality of information sources and for making the aggregated product information available to potential consumers of the products. At step 502, the aggregation module 200 receives the product information 108 and assigns the unique identifier 111 to each product definition 107 associated with the product information 108. At step 504, the classification module 204 determines at least one classification for each of the product definitions 107 according to a set of predefined classifications 205. At step 506, the module 204 facilitates storage of the generated product definitions 107 according to the respective at least one classification 205 and the respective unique identifier 111, such that the product definitions 107 are retrievable from the storage 110 in view of search parameters 99 received from the potential consumer 104 for the product defined in the product definition 107. At step 508, the update module 206 receives update information 109 associated with the specified unique identifier 111; and amends with the update information 109 the product definition 107 in the storage 110 matching the specified unique identifier 111.

At step 510, the network interface module 202 receives a search request 105 containing at least one search parameter 99 for matching with the respective at least one classification 205 to identify a plurality of the product definitions 107 in the storage 110 having the at least one classification 205. At step 512, the publication module 208 matches the classifications 205 in the search request 105 with the classifications 205 assigned to the product definitions 107 in the storage to obtain the appropriate product definitions 107 for sending at step 514 back to the consumer 104 as the search results 106. Further, it is recognised that the publication module 208 can generate the format of the matched product definitions 107 as display data suitable for use in subsequent rendering of the matched product definitions 107 on a display (e.g. user interface 302 of the consumer device 101—see FIG. 3).

In view of the above, an information input system 10 is described for making product information 108 published in physical (e.g. flyers, magazines, newsprint) advertisements available in the electronic database 110. The product information 108 is aggregated in the electronic database 110 to facilitate searching of any subset of the information via search terms 99 (e.g. classifications 205). Once in the database 110, consumers 104 can access the information via a Web portal through a Web search engine provided by the framework 112, i.e. the consumers via their browser access the contents of the electronic database 110 over the Internet via the Web portal that hosts the Web search engine. For example, the consumers 104 could search vehicle “for sale” information in the database 110 to find the lowest advertised new vehicle prices in various markets across the country. The aggregation (and classification) of the product information 108 in the database 110 (as sourced from various independent physical advertisements and information sources 114) can allow for higher efficiency and data integrity through vertical specialization, such that the product definitions 107 are organized as product and/or vendor centric (e.g. vehicle and dealership centric input), for example. Therefore, instead of the consumer 104 typing a product of vendor name in the search engine search string (e.g. a vehicle or dealership name), the consumer 104 can chose a name from a list (e.g. control elements 252 that can be updated regularly). Also, a copy of the original physical ad (that originated the product data) could be coupled to the product definitions 107 in the electronic database 110, and thus accessible by the consumer 104. Also provided is the capability to perform periodic updates of the classification 205 and/or product definitions 107 reflect vendor database information (e.g. DMS info) changes.

We claim:

1. A framework for aggregating a plurality of product information accessed from a plurality of information sources, the framework comprising:
an aggregation module for receiving the product information and for assigning a unique identifier to each product definition associated with the product information;
a classification module for determining at least one classification for each of the product definitions according to a set of predefined classifications;
a storage for storing each of the product definitions according to the respective at least one classification and the respective unique identifier, such that the product definitions are retrievable from the storage in view of search parameters received from a potential consumer for the product defined in the product definition; and
an update module for receiving update information associated with a specified unique identifier and for amending with the update information the product definition in the storage matching the specified unique identifier.

2. The framework of claim 1, wherein the predefined classifications are selected from the group comprising: product type; product pricing; product availability; product location; retailer location; and retailer identification information.

3. The framework of claim 2, wherein the update information is selected from the group comprising: product unavailability and product pricing change.

4. The framework of claim 3, wherein the update information contains information intended to update data in the storage selected from the group comprising: the type of the classifications of the product definition, the content of the classifications of the product definition; and product details of the product definition.

5. The framework of claim 4, wherein the product definition is an advertisement and the product is a vehicle.

6. The framework of claim 2 further comprising the classification module configured for generating the product definitions from the product information based on a product definition template.

7. The framework of claim 6, wherein the product definition template includes components selected from the group comprising: a product image; a product name; product pricing; product location; retailer location; retailer contact details; and product descriptive details.

8. The framework of claim 2 further comprising a network interface module for receiving a search request containing at least one search parameter for matching with the respective at least one classification to identify a plurality of the product definitions in the storage having said at least one classification.

9. The framework of claim 8 further comprising a publication module for generating the matched product definitions as display data suitable for use in subsequent rendering of the matched product definitions on a display.

10. The framework of claim 9, wherein the product definition is an advertisement and the product is a vehicle.

11. A method for aggregating a plurality of product information accessed from a plurality of information sources, the method comprising the acts of:
receiving the product information and assigning a unique identifier to each product definition associated with the product information;
determining at least one classification for each of the product definitions according to a set of predefined classifications;
storing each of the product definitions according to the respective at least one classification and the respective unique identifier, such that the product definitions are retrievable from the storage in view of search parameters received from a potential consumer for the product defined in the product definition;
receiving update information associated with a specified unique identifier; and
amending with the update information the product definition in the storage matching the specified unique identifier.

12. The method of claim 11, wherein the predefined classifications are selected from the group comprising: product type; product pricing; product availability; product location; retailer location; and retailer identification information.

13. The method of claim 12, wherein the update information is selected from the group comprising: product unavailability and product pricing change.

14. The method of claim 13, wherein the update information contains information intended to update data in the storage selected from the group comprising: the type of the classifications of the product definition, the content of the classifications of the product definition; and product details of the product definition.

15. The method of claim 14, wherein the product definition is an advertisement and the product is a vehicle.

16. The method of claim 12 further comprising the act of generating the product definitions from the product information based on a product definition template.

17. The method of claim 16, wherein the product definition template includes components selected from the group comprising: a product image; a product name; product pricing; product location; retailer location; retailer contact details; and product descriptive details.

18. The method of claim 12 further comprising the act of receiving a search request containing at least one search parameter for matching with the respective at least one classification to identify a plurality of the product definitions in the storage having said at least one classification.

19. The method of claim 18 further comprising the act of generating the matched product definitions as display data suitable for use in subsequent rendering of the matched product definitions on a display.

20. The method of claim 19, wherein the product definition is an advertisement and the product is a vehicle.

21. A framework for aggregating a plurality of vehicle information accessed from a plurality of dealership information sources, the framework comprising:
an aggregation module for receiving the vehicle information and for assigning a unique identifier to each defined vehicle advertisement associated with the vehicle information;
a classification module for determining at least one classification for each of the vehicle advertisements according to a set of predefined classifications;
a storage for storing each of the vehicle advertisements according to the respective at least one classification and the respective unique identifier, such that the vehicle advertisements are retrievable from the storage in view of search parameters received from a potential consumer for the vehicle defined in the vehicle advertisement; and
an update module for receiving update information associated with a specified unique identifier and for amending with the update information the vehicle advertisement in the storage matching the specified unique identifier.
